(19) United States
(12) Patent Application Publication
(10) Pub. No.: US 2020/0111050 A1
(43) Pub. Date: Apr. 9, 2020

(54) METHOD AND APPARATUS FOR VEHICLE-ASSISTED DELIVERY FULFILMENT

(71) Applicant: FORD GLOBAL TECHNOLOGIES, LLC, Dearborn, MI (US)

(72) Inventors: Tai LUU, Westland, MI (US); Doug Vi LUU, Westland, MI (US)

(21) Appl. No.: 16/152,055

(22) Filed: Oct. 4, 2018

(51) Int. Cl. G06Q 10/08; G06Q 10/10; G07C 9/00; G01C 21/34

(52) U.S. Cl. CPC G06Q 10/0833; G01C 21/3438; G07C 9/00896; G06Q 10/1097

(57) ABSTRACT

A system includes a processor configured to receive a request for a delivery of a package to a vehicle. The processor is also configured to determine a vehicle location for request-fulfillment. The processor is further configured to determine an ingress to the vehicle, based on received package dimensions. Also, the processor is configured to schedule the delivery, responsive to the request. The processor is additionally configured to detect an arrival of the delivery and provide vehicle access via the ingress, responsive to verifying the delivery.

### TECHNICAL FIELD

The illustrative embodiments generally relate to methods and apparatuses for vehicle assisted delivery fulfillment.

### BACKGROUND

While online ordering has become quite a common practice, people often have goods delivered to their office building, to avoid having the delivery sit on a front-porch all day until they return home. This can create a hassle for a receptionist, as well as result in misplacement of delivered goods.

Most people accept the realities of the risks associated with goods on their porch, and still choose to order online. But, especially around holidays, front porch theft has become an ever-increasing problem, resulting recently in tens of millions of stolen packages in a single year. This has caused many delivery services to offer increased pickup points, which saves the cost of final delivery and the risk of theft, but increases the nuisance to the customer, who then has to stop on the way home from the office, or make a trip out to the pickup, to obtain the package.

With the ever-increasing growth of online retail, one can only expect opportunistic parties to continue to abuse the trust system involved in leaving a package on a front-porch.

### SUMMARY

In a first illustrative embodiment, a system includes a processor configured to receive a request for a delivery of a package to a vehicle. The processor is also configured to determine a vehicle location for request-fulfillment. The processor is further configured to determine an ingress to the vehicle, based on received package dimensions. Also, the processor is configured to schedule the delivery, responsive to the request. The processor is additionally configured to detect an arrival of the delivery and provide vehicle access via the ingress, responsive to verifying the delivery.

In a second illustrative embodiment, a computer-implemented method includes sending a notification to a user, responsive to a received indicator of a failure to deliver a package to a vehicle using a preselected vehicle ingress. The method also includes receiving a designation of a second vehicle ingress from the user, responsive to sending the notification. The method further includes providing access to the second ingress, responsive to receiving the designation.

In a third illustrative embodiment, a system includes a processor configured to receive notification of a failed delivery and a scanned image of a packing code. The processor is also configured to determine a recipient based on the scanned image. The processor is further configured to notify the recipient of the failed delivery. Also, the processor is configured to receive alternative access instructions, responsive to the notification, and send instructions to a vehicle, identified as belonging to the recipient, to open an ingress in accordance with the alternative access instructions.

### BRIEF DESCRIPTION OF THE DRAWINGS

FIG. 1 shows an illustrative vehicle computing system;

FIG. 2 shows an illustrative delivery planning process;

FIG. 3 shows an illustrative delivery completion process; and

FIG. 4 shows an illustrative vehicular assistance process.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

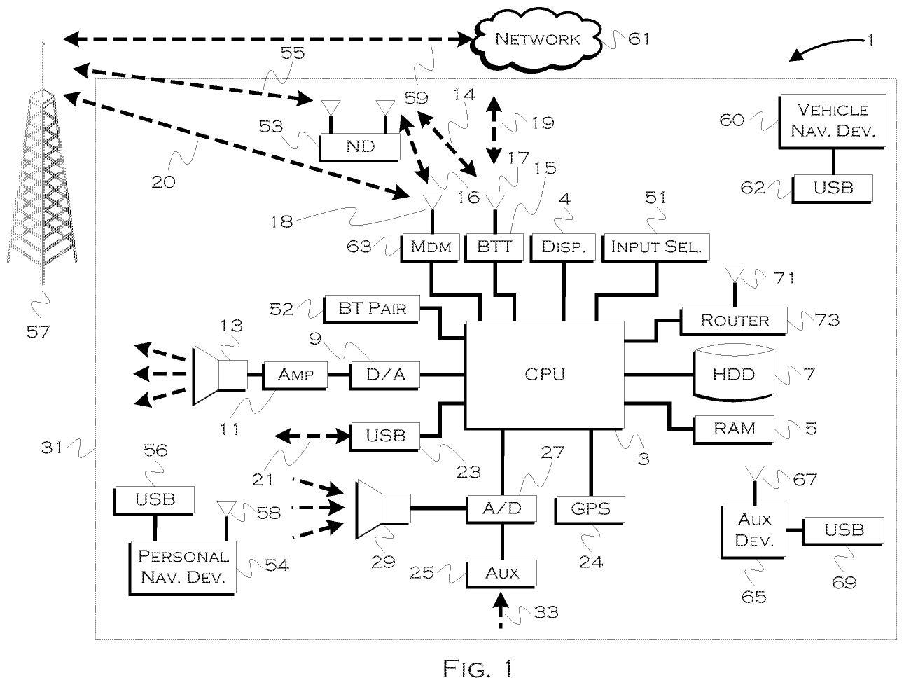

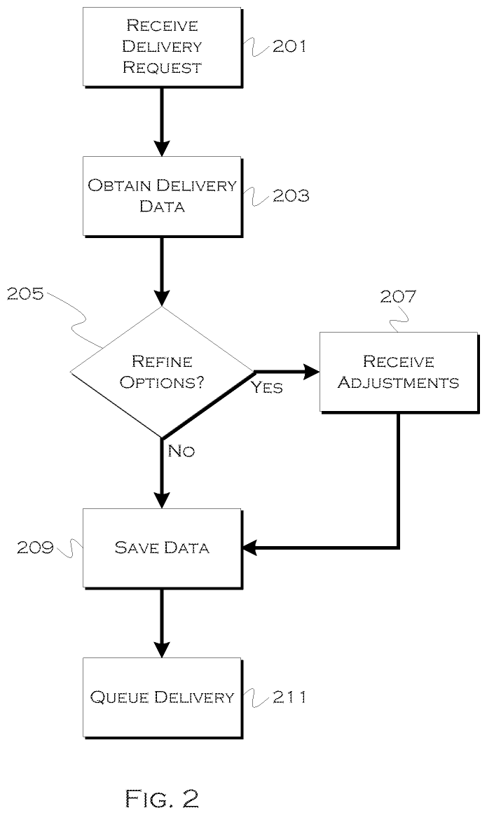

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

By allowing for vehicle-centric delivery, and for access to the vehicle and securing a delivery within the vehicle, the illustrative concepts and embodiments provide opportunities to improve the utility and functionality of traditional “drop off” delivery services. Leveraging the ability of a vehicle to selectively allow access, which may even be limited to package-size, provides enhanced vehicle security for the user and still allows for package delivery. The novel, uncommon and atypical examples and concepts described herein demonstrate potential improvements achievable through use of those examples, concepts, and the like.

The illustrative embodiments propose use of a vehicle computing system in conjunction with a delivery system to allow for vehicle-centric package delivery. The vehicle could be provided with a package receipt bay, or could open a window, trunk or door, as appropriate, to allow package drop-off. The vehicle can also work with the delivery service to remain secure until the appropriate time, meaning users will not have to leave a vehicle open or unlocked to facilitate delivery. In some instances, delivery of a code or digital key can also facilitate the process, and the code or key can have limited enablement, preventing its use outside a specified time window and/or other than for a specified purpose.

Because vehicles may be provided with remote communication in some instances, those vehicles can receive live-updates on delivery driver arrival timing, and can self-select entry parameters and even contact owners about delivery completion. For unconnected vehicles, codes and preset parameters can still facilitate delivery, even if the vehicle itself is offline while parked and while the owner is away.

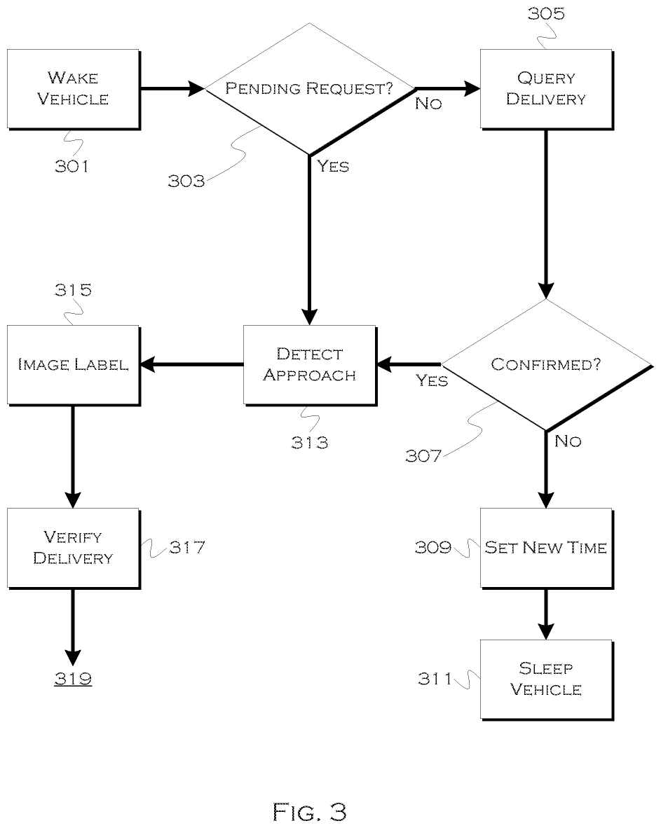

FIG. 2 shows an illustrative delivery planning process. In this example, an owner receives 201 a request for at-vehicle delivery. This could be part of an order completion process, or could be sent to a mobile application or to a vehicle HMI. The owner could also be notified when a package was locally available, and could choose this option at any reasonable time before the package was actually delivered elsewhere. So, for example, if the owner was unexpectedly away from home, the owner could elect at-vehicle delivery on the day of delivery, and have the package delivered directly to a vehicle.

The process also determines 203 delivery data, which includes, for example, owner location or expected location (i.e., where the vehicle will be located at delivery time) and package parameters. The location data can be derived from a parked vehicle location or can be based on a route destination, for example, or another owner indicator about where the vehicle will be located and when. While the delivery service may adapt to a moving vehicle, it will often then be incumbent on the owner to ensure the vehicle is at a predefined location once delivery is agreed-upon.

The owner can be provided with a proposed delivery type, for example, a small package may be dropped through a partially opened window. The vehicle can be self-aware of its own dimensions, and can thus recommend an ingress through which the package can be delivered based on known package dimensions. The owner may also refine 205 the options, which can include specifying a destination and/or ingress.

For example, if the package includes delicate material, the owner may not want it dropped through an open window and instead may elect to enable door-unlock or trunk-delivery. In another example, the owner may choose a trunk over a vehicle interior access, if the vehicle contains valuables. If the package dimensions are large enough that trunk delivery may be difficult, the process could notify the owner, so as not to create a delivery-issue.

After receiving 207 any delivery refinements, if desired, the process saves 209 the delivery information and schedules 211 the delivery. This can include queuing the delivery in a vehicle system, and may involve transfer of relevant data to the vehicle if the scheduling was done on a mobile device or other non-vehicle computer. The queuing could also be cloud-based, if the vehicle was connected to the cloud when parked, allowing for cloud-scheduling and fulfillment of delivery-completion without having to store the information locally on the vehicle. That is, the cloud could detect arrival of the driver, instruct opening of the ingress, and relock/reseal the vehicle following delivery.

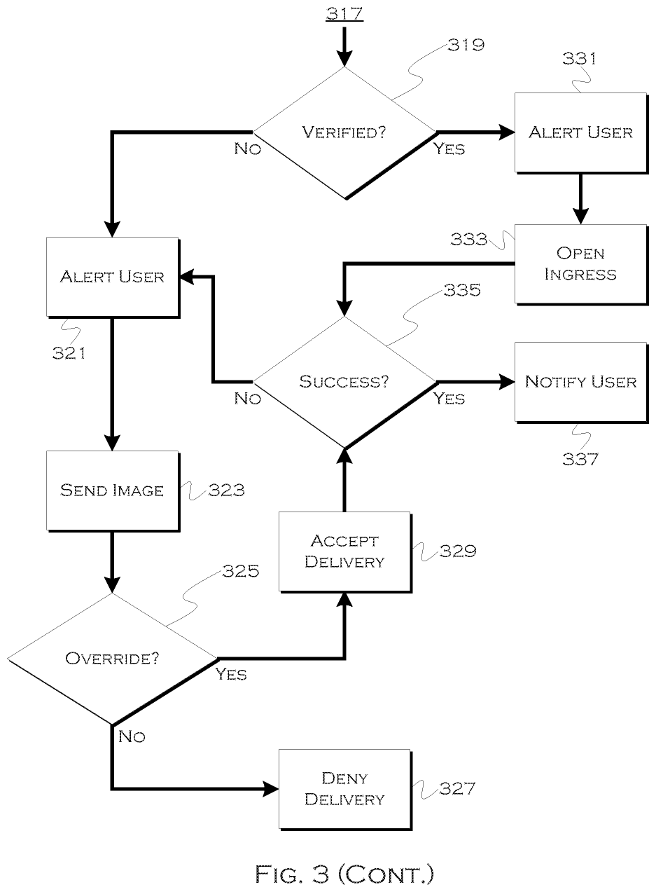

FIG. 3 shows an illustrative delivery completion process. This is an example of the vehicle fulfilling the delivery completion, but the same processes could easily be run remotely in conjunction with a connected vehicle. In this example, the process will wake 301 the vehicle at a prespecified time or at periodic intervals, depending, for example, on how precise of a delivery window exists. With connected vehicles, the delivery service may send an out-for-delivery request to the vehicle, so the vehicle, upon waking, may receive or detect 303 a pending delivery request. If the delivery was delayed, for example, the request may not be present and the vehicle may query 305 the delivery service for a new expected arrival time.

If the service confirms 307 the impending delivery, the process can continue with access provision, but otherwise the process may receive 309 a new time for delivery, which allows the process to then put 311 the vehicle back to sleep until a time coordinated to the new scheduled delivery. For example, the vehicle may wake at 12:45 PM, expecting a 1:00 PM delivery, but then receive information that the delivery will now be at 2:00 PM. The vehicle can then resume a sleep state until 1:45 PM, for example.

When the vehicle has confirmed a delivery, the vehicle may track 313 the approach of a driver through information provided wirelessly. When the vehicle lacks long-range connectivity, it may forego the wake and check portions of the process and wait for a physical or local interaction (e.g., a code or short range wireless signal) to enable delivery completion.

In this example, once the vehicle confirms the driver is on-site, a vehicle-based scanner or camera can image 315 a package label. This allows the vehicle to compare 317 the scanned data to a locally stored code or remotely stored code, and has the added side-benefit of avoiding mis-delivery of a given package. Once the vehicle has verified 319 the label as the appropriate delivery, the process can, in this example, alert 331 the user that the delivery is being completed. This may be done solely for the sake of the user knowing the package is delivered, and does not necessarily include any direct confirmation from the user.

The process can also then open the predetermined ingress, such as a door, window or trunk. With a window, the process may only open the ingress a certain amount. An interior sensor may be used to verify successful delivery, or the driver could manually verify that the package had been delivered.

If the delivery was a success 335, the process may notify 337 the user that the package has been delivered. If the delivery failed (e.g., the package could not fit through the ingress or within an interior space, or if the shipping label was damaged and could not be verified, for example, the process may alert 321 the user for the purpose of obtaining override approval.

In this example, the notification may include 323 an image of the package, which can include a damaged shipping label or a driver image, and may even include a visual confirmation (if the appropriate camera is available) of the package being unable to fit within the original predefined ingress or vehicle interior.

The user has the option to override 325 the ingress and specify 329 a new ingress, which can include designation of a new door or trunk, or can include new window opening parameters (e.g., roll the window down all the way, as opposed to a previous half-roll). The driver may also provide a suggestion or preferred ingress, which the user could accept as part of the override. If the user does not trust the package or driver, or does not wish to accept the delivery through a new ingress, the process can deny 327 the delivery, which can include closing or locking the initial ingress and/or notifying the driver of the denial. The process may also close or lock the initial ingress upon provision of a new ingress, except in cases where the ingress is a window which will be opened further, in which case the processor may simply expand the opening without closing it until after the delivery is completed.

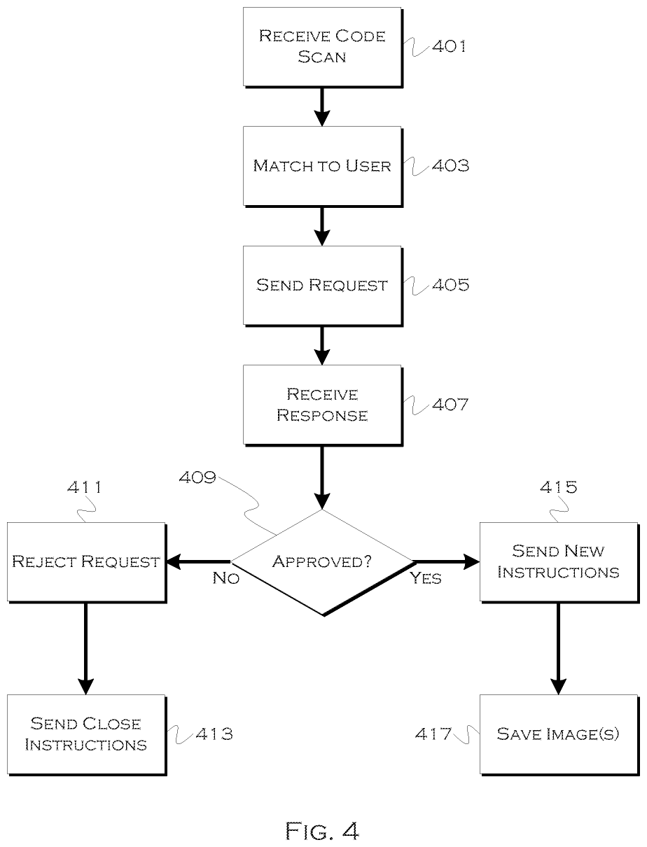

FIG. 4 shows an illustrative vehicular assistance process. This is an example of how the cloud may interact with a vehicle to assist in the event of a failed delivery due to an ingress being inappropriate for a given delivery. This is just one example of how such an interaction could occur, but serves to show that the delivery can be adapted to changing needs or unexpected situations (e.g., the driver may not want to leave a delivery of food in direct sunlight on a hot day, even if the opening is large enough).

In this example, the driver may have attempted to already deliver the goods to the vehicle, and encountered an issue. The driver can connect to the cloud and send a suggested alternative, or simply describe the problem and/or request different access. The cloud can receive 401 a copy of the scanned code, which allows that process to match 403 the code to a particular user.

The cloud can then send 405 a request to the matched user, which may include driver suggestions and/or a description of the issue with the delivery. At this point, the user could use a mobile application or PC, for example, to redefine delivery parameters if alternative access was still intended, and the cloud could receive 407 the response.

If the user has approved 409 a new delivery attempt, the process can send 415 new access instructions to a vehicle. This can include, for example, instructions to open a new ingress, defined in a user response, or instructions to open an ingress suggested by the delivery driver. The process may also save 417 any images of the package and driver, which may be useful for security purposes, especially when the driver is accessing a wider opening or a less secure vehicle interior.

If the user declines the new attempt, the process may send 411 rejection notification to the vehicle and/or driver. The process may also send 413 instructions to close or lock a previously opened ingress, and these same instructions may be sent if a new ingress is opened pursuant to an owner approval. If the driver fails to close a locked door or trunk, the process could also notify the owner of the still-open vehicle. A local process at the vehicle could also alert the driver or request that the driver fully close a now-locked ingress.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
receive a request for a delivery of a package to a vehicle;
determine a vehicle location for request-fulfillment;
determine an ingress to the vehicle, based on received package dimensions;
schedule the delivery, responsive to the request;
detect an arrival of the delivery; and
provide vehicle access via the ingress, responsive to verifying the delivery.

2. The system of claim 1, wherein the processor is configured to determine the destination as a current vehicle location.

3. The system of claim 1, wherein the processor is configured to determine the destination as a current vehicle route destination.

4. The system of claim 1, wherein the processor is configured to determine the destination based on vehicle owner input.

5. The system of claim 1, wherein the processor is further configured to determine the ingress based additionally on the package dimensions compared to vehicle interior parameters of an interior to which the ingress provides access.

6. The system of claim 1, wherein the processor is configured to detect the arrival based on a wireless notification, received by the processor, indicating arrival of a deliverer of the package to the vehicle.

7. The system of claim 6, wherein the wireless notification includes short-range communication.

8. The system of claim 6, wherein the wireless notification includes long-range communication.

9. The system of claim 1, wherein the processor is configured to detect the arrival based on a physical interaction of the vehicle with a delivery entity.

10. The system of claim 9, wherein the physical interaction includes input of a code to the vehicle, provided as part of scheduling the delivery.

11. The system of claim 9, wherein the physical interaction includes scanning a package label via a scanner of the vehicle.

12. The system of claim 1, wherein the ingress includes a window and the providing access includes lowering the window a predetermined amount.

13. The system of claim 1, wherein the ingress includes a door and the providing access includes unlocking the door.

14. The system of claim 1, wherein the ingress includes a trunk the providing access includes unlocking the trunk.

15. A computer-implemented method comprising:
responsive to a received indicator of a failure to deliver a package to a vehicle using a preselected vehicle ingress, sending a notification to a user;
responsive to sending the notification, receiving a designation of a second vehicle ingress from the user; and
responsive to receiving the designation, providing access to the second ingress.

16. The method of claim 15, further comprising closing or locking the preselected ingress provided for an initial delivery attempt resulting in the failure to deliver.

17. The method of claim 15, further comprising providing access to the second ingress in a manner limited by parameters included with the received designation.

18. A system comprising:
a processor configured to:
receive notification of a failed delivery and a scanned image of a packing code;
determine a recipient based on the scanned image;
notify the recipient of the failed delivery;
responsive to the notification, receive alternative access instructions; and
send instructions to a vehicle, identified as belonging to the recipient, to open an ingress in accordance with the alternative access instructions.

19. The system of claim 18, wherein the notification to the recipient includes an issue defined by the delivery driver and included in the notification of failed delivery received from the driver.

20. The system of claim 18, wherein the processor is further configured to send instructions to the vehicle to close or lock an initial ingress, opened or unlocked to facilitate an initial delivery attempt.
